(19) United States
(12) Patent Application Publication
(10) Pub. No.: US 2011/0311313 A1
(43) Pub. Date: Dec. 22, 2011

(54) METHOD FOR MOUNTING A TUBE IN THE GROUND

(76) Inventor: Pertti Pajunen, Harjavalta (FI)

(21) Appl. No.: 13/254,460

(22) PCT Filed: Mar. 1, 2010
(86) PCT No.: PCT/FI10/00015

§ 371 Date: Sep. 2, 2011

(30) Foreign Application Priority Data
Mar. 3, 2009 (FI) 20090072

(51) Int. Cl. F16L 1/00

(52) U.S. Cl. 405/183

(57) ABSTRACT

Method for mounting a pipe (3, 4) into a soil in which case the pipe (3, 4) is intended to be left in a hole drilled in the soil in which method the drilling of the hole is performed by using hollow drill rods (1) attached sequentially to each other the diameter of which hollow drill rods is essentially similar to the diameter of the drilled hole and the hollow drill rods (1) are essentially empty from the drilling equipment during the drilling and the mentioned pipes (1) are adjusted to convey both rotating motion and propulsive force to a drill head (9,10). The pipework (3),(4) staying in the soil is mounted into the hole by pulling the pipework to the drill head with the help of a plunger (7) pushed by a pressurized medium in which case the drill rod pipework (1) functions as a cylinder for the mentioned plunger (7) and that finally the hollow drill rods (1) are pulled out of the hole and the pipework and the plunger (7) are left in the hole.

The invention relates to a method for mounting a tube into a soil in which case the tube is meant to be left in a hole drilled into the soil in which method the drilling of the hole is performed by using hollow drill rods attached sequentially to each other the diameter of which hollow drill rods is essentially similar to the diameter of the drilled hole and the hollow drill rods are essentially empty regarding the drilling equipment during the drilling and the mentioned tubes are adjusted to convey both rotating motion and propulsive force to a drill head.

Previously from the published application FI-20060473 a method according to the above mentioned preamble is known for installing the pipework to the finite hole. In this known case the pipe/pipes staying in the soil are pushed inside hollow drill rods till the drill head and after that the drill rods are pulled out of the hole. The drilling head that performed the drilling also stays in the hole or it can be turned in various ways when the extraction begins so that it can follow the drill rods out of the hole and does not harm the pipes that have been pushed into the hole.

This known method has the disadvantage that the pushing of the pipes inside the drill rods is difficult and sometimes even impossible because usually these kind of pipes arrive at the site being coiled and when they are unwounded from the coil and they are pushed for long distances, for example 100-200 m inside the hollow drill rods, then the pipes to be pushed tend to bend strongly against the walls of the drill rods. The friction being formed hinders and finally prevents the pipes from going further. The pipes cannot be pulled into the hole at the same time during the drilling because the hollow drill rods rotate during the drilling and the hollow drill rods must be easy to attach after the previous hollow drill rods at the pushing end.

With the method according to the invention the problems relating to the pushing of the pushable pipes into the hole inside the hollow drill rods are solved and it is characteristic of the invention that the pipework staying in the soil is located into the hole by pulling the pipework with the help of a plunger being pushed by a pressurized medium to the drill head in which case the drill rod pipework functions as a cylinder for the mentioned plunger and that finally the hollow drill rods are pulled out of the hole and the pipework and the plunger are left inside the hole.

The advantage of the method according to the invention is that with the help of hydrostatic pressure or air pressure the plunger moves reliably inside the hollow drill rods because the inner surfaces of the hollow drill rods are even enough and the plunger that has to be left in the hole can have a very light structure, such as to be mainly cast from urethane to be a cylindrical piece in which case it does not need any other seal against the inner surface of the drill rods. Also the plunger can comprise an outer edge made of rubber for the sealing and otherwise it can be made of metal. A sufficient attractive force to the plunger can be achieved already with the pressure of a couple of bars when the drill rods in these solutions usually have a diameter of about 100-200 mm.

In the following the invention is described more detailed by referring to the accompanying drawings in which

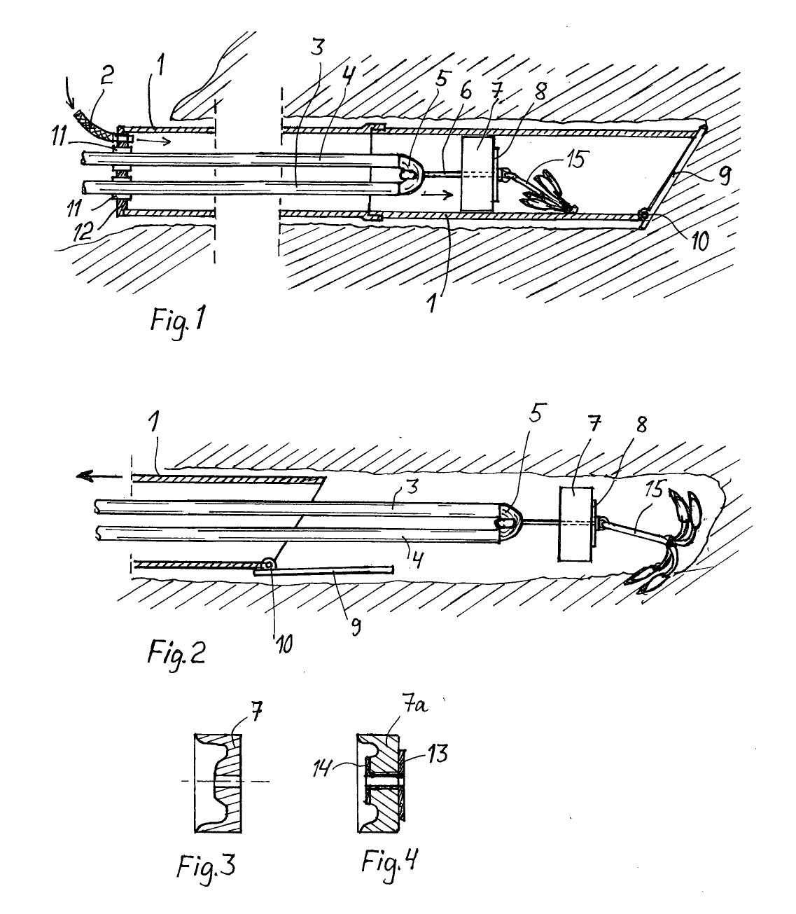

FIG. 1 shows the pulling of the pipes with the help of the plunger towards the drill head.

FIG. 2 shows the solution of the FIG. 1, the drill rods are pulled away from the hole.

FIG. 3 shows a plunger as a section view.

FIG. 4 shows another plunger as a section view.

In the FIG. 1 there is a hole drilled into the soil with the help of drill rods 1 and a cutting plate 9 located diagonally to the drill head. The drill rods 1 are rotated and pushed at the starting end. The movement of the drill head is directed along a direct line known as such by rotating the drill rods and the drill head with constant speed. A change to the direction of advance can be achieved by stopping or slowing the rotating in a certain angle area of the rotation in which case the inclinedly installed cutting plate 9 steers the head away from the straight line. With the cutting plate 9 a clearly larger hole regarding its diameter is drilled than what the diameter of the drill rods 1 is. With this for example the extraction of the drill rods is ensured.

In the FIG. 1 the drilling has been concluded and the pipework 3,4 intended to be left in the soil is located inside the drill rods 1. According to the invention the pipework 3,4 is pulled to the drill head with the help of the plunger 7 by directing the hydrostatic pressure along the pipe 2 inside the drill rods 1. The plunger 7 starts to move inside the drill rods and pulls the pipes 3,4 to the drill head. There is a support flange 8 at the front side of the plunger 7 and it conveys the pulling force to a pulling rod 6 that is adjusted to grip the curve piece 5 combining the pipes 3, 4 with its hook-like head. In front of the plunger 7 also an anchorage device 15 being drawn up is pushed to the hole which anchorage device slides easily forwards along the even inner surface of the drill rod.

There is no drilling equipment in the hole inside the drill rods 1 that would prevent the plunger 7 from moving. There is no earth and hardly any water. However there may be water when it has been directed to the drill head during the drilling so that the soil would soften and it would make the drilling easier. The water however can easily disappear in front of the plunger 7 for example outside the drill rods 1 even back to the starting end. Usually this water can be absorbed into the soil as the drilling progresses.

In the FIG. 2 a situation is shown where the drill rods 1 have been pulled a little bit out of the hole. The cutting plate 9 has been turned almost to a landscape orientation and the pipework 3, 4 has stayed at its place or it has possibly moved aback with the drill rods 1. The extraction of the drill rods is stopped at this point and the plunger 7 is pushed again deeper into the hole with hydrostatic pressure so that the anchorage device 15 and the plunger come out of the drilling head into the soil.

When at the next step the extraction of the hollow drill rods is started again, the anchorage device 15 opens in the hole and stops the movement of the pipework 3, 4. The anchorage device is advantageously at the opened stage considerably wider than the drilled hole. Also the anchorage device always stays in the hole.

The hole according to the FIG. 2 collapses gradually and the soil becomes attached to the pipes 3, 4 and they function after that reliably for example as recovery pipes of ground heat. The cutting plate 9 has been turned around the hinge 10 in a pulling direction in which case it does not resist the extraction much.

FIG. 3 shows a plunger 7 that is cast from urethane in which case its structure is knowingly self sealing, in other words the pressure that has been directed to the left side of he plunger also presses the skirt portion of the outer edge of the plunger against the inner surface of the drill rods 1.

FIG. 4 shows a plunger 7a in which the body is appropriate rubber regarding its degree of hardness and the plunger is supported with metallic flanges 13, 14 and with sleeves combining them. The plunger 7a is thus steady enough regarding its body for a pulling purpose.

1. Method for mounting a pipe (3, 4) into a soil in which case the pipe (3, 4) is intended to be left in a hole drilled in the soil in which method the drilling of the hole is performed by using hollow drill rods (1) attached sequentially to each other the diameter of which hollow drill rods is essentially similar to the diameter of the drilled hole and the hollow drill rods (1) are essentially empty from the drilling equipment during the drilling and the mentioned pipes (1) are adjusted to convey both rotating motion and propulsive force to a drill head (9,10), characterized in that the pipework (3),(4) staying in the soil is mounted into the hole by pulling the pipework to the drill head with the help of a plunger (7) pushed by a pressurized medium in which case the drill rod pipework (1) functions as a cylinder for the mentioned plunger (7) and that finally the hollow drill rods (1) are pulled out of the hole and the pipework and the plunger (7) are left in the hole.

2. Method according to the claim 1, characterized in that the plunger (7) that pulls the pipework (3), (4) is pushed with the help of pressurized water or air.

3. Method according to the claim 1, characterized in that the staying of the pipework (3, 4) in a hole when the drill rods are being pulled out is ensured with an anchorage device (15) that is combined to the pulling equipment of the pipework (3, 4) and that locks to the hole at least in a situation where it is pulled in an extraction direction of the drill rods.

4. Method according to the claim 1, characterized in that a boring head (9, 10) that stays in the drill head or can be pulled out of there with the drill rods (1) is used as a drill head.

5. Method according to the claim 1, characterized in that a inclinedly directed cutting plate (9) is used as a drilling head which plate turns in a pulling direction to be an easily progressing plane when it is being pulled out of the hole.

6. Method according to the claim 1, characterized in that a cylindrical piece is used as a plunger (7) which piece has elastic material, such as rubber or urethane at least at its outer edges.
